(19) United States
(12) Patent Application Publication
(10) Pub. No.: US 2025/0357790 A1
(43) Pub. Date: Nov. 20, 2025

(54) HAIR TRIMMER WIRELESS CHARGE MAT

(71) Applicant: PWRD PRO LLC, College Station, TX (US)

(72) Inventor: Jonathan BALBOA, Somerville, TX (US)

(73) Assignee: PWRD PRO LLC, College Station, TX (US)

(21) Appl. No.: 19/211,987

(22) Filed: May 19, 2025

Related U.S. Application Data
(60) Provisional application No. 63/649,032, filed on May 17, 2024.

(51) Int. Cl. H02J 50/00; B26B 19/38; H02J 50/10; H02J 50/40; H02J 50/90

(52) U.S. Cl. CPC H02J 50/005; B26B 19/388; H02J 50/10; H02J 50/402; H02J 50/90

(57) ABSTRACT

A wireless charge mat for charging hair trimmers including a body having a top surface with at least one magnetic contact charging point operatively attached thereto for receiving a hair trimmer adapted for wireless charging. A kit, including the wireless charge mat, at least one wireless charging adapter for adapting a hair trimmer to receive wireless charge, and instructions for use. A method of using the wireless charge mat, by adapting a hair trimmer for wireless charging, placing the hair trimmer on a magnetic contact charging point of the wireless charge mat, and charging the hair trimmer.

### BACKGROUND OF THE INVENTION

### 1. Technical Field

The present invention relates to compositions and methods for charging hair trimmers. More specifically, the present invention relates to devices for charging hair trimmers wirelessly.

### 2. Background Art

Hair trimmers or clippers can be used professionally by barbers or by individuals for trimming hair on the head or facial hair. Typically, hair trimmers either plug in directly to an outlet for power or are rechargeable by plugging into an outlet and recharging a rechargeable battery inside the hair trimmer. Barbers use multiple hair trimmers during the day (such as 3-5 different hair trimmers), and they need a fast, convenient, and efficient way to charge multiple hair trimmers. It would be advantageous to be able to charge hair trimmers wirelessly, so that cords do not get tangled or hang in undesirable areas, especially when there is a need to charge multiple hair trimmers at once.

TOMB45™ makes a wireless charging mat that provides wireless charging for clippers, trimmers, and shavers. TOMB45™ uses inductive coils for wireless charging that require a precise placement of clippers in order for charging to occur. Inductive coils also lack efficiency in charging.

Therefore, there remains a need for a mechanism to charge hair trimmers wirelessly that provides more efficient charging and is easier to use.

### SUMMARY OF THE INVENTION

The present invention provides for a wireless charge mat for charging hair trimmers including a body having a top surface with at least one magnetic contact charging point operatively attached thereto for receiving a hair trimmer adapted for wireless charging.

The present invention also provides for a kit, including the wireless charge mat, at least one wireless charging adapter for adapting a hair trimmer to receive wireless charge, and instructions for use.

The present invention provides for a method of using the wireless charge mat, by adapting a hair trimmer for wireless charging, placing the hair trimmer on a magnetic contact charging point of the wireless charge mat, and charging the hair trimmer.

### DESCRIPTION OF THE DRAWINGS

Other advantages of the present invention are readily appreciated as the same becomes better understood by reference to the following detailed description when considered in connection with the accompanying drawings wherein:

FIG. 1 is a top perspective view of a wireless charge mat for a single hair trimmer;

FIG. 2 is a top view of a wireless charge mat for a single hair trimmer;

FIG. 3 is a top perspective view of a wireless charge mat for a single hair trimmer;

FIG. 4 is a top view of a wireless charge mat for multiple hair trimmers;

FIG. 5 is a top view of a wireless charge mat for multiple hair trimmers with a hair trimmer charging;

FIG. 6 is a side view showing charging indicator lights;

FIG. 7 is a top perspective view of a wireless charge mat for multiple hair trimmers with a hair trimmer charging;

FIG. 8 is a top perspective view of a wireless charge mat and cover;

FIG. 9 is a top perspective view of a wireless charge mat and cover;

FIG. 10 is a close up view of a power cable;

FIG. 11 is a top perspective view of a wireless charge mat for multiple hair trimmers with a hair trimmer charging and wireless charging surfaces;

FIG. 12 is a front perspective view of a wireless charge mat for multiple hair trimmers with wireless charging surfaces and a magnetic strip;

FIG. 13 is a detailed view of a hair trimmer connected to a magnetic contact charging point;

FIG. 14 is a detailed view of a magnetic contact charging point;

FIG. 15A is a top view of a wireless charging adapter, FIG. 15B is a bottom view of a wireless charging adapter, and FIG. 15C is a front view of a wireless charging adapter; and

FIG. 16 is a detailed view of a wireless charging adapter connected to a hair trimmer.

### DETAILED DESCRIPTION OF THE INVENTION

The present invention provides for a wireless charge mat for hair trimmers, shown generally at 10 in the FIGURES. The wireless charge mat 10 includes a body 12 having a top surface 14 with at least one magnetic contact charging point 16 operatively attached thereto for receiving a hair trimmer 18 adapted for wireless charging. It should be understood that while hair trimmers are generally referred to herein, any hair cutting device can also be used such as hair clippers or razors.

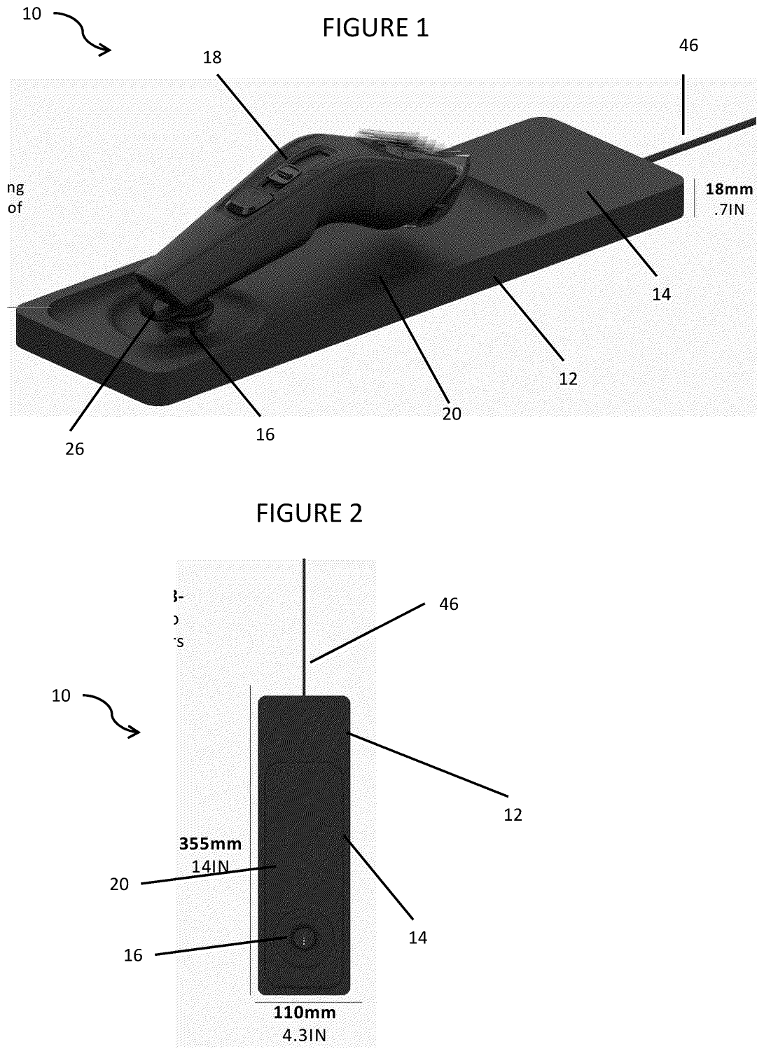

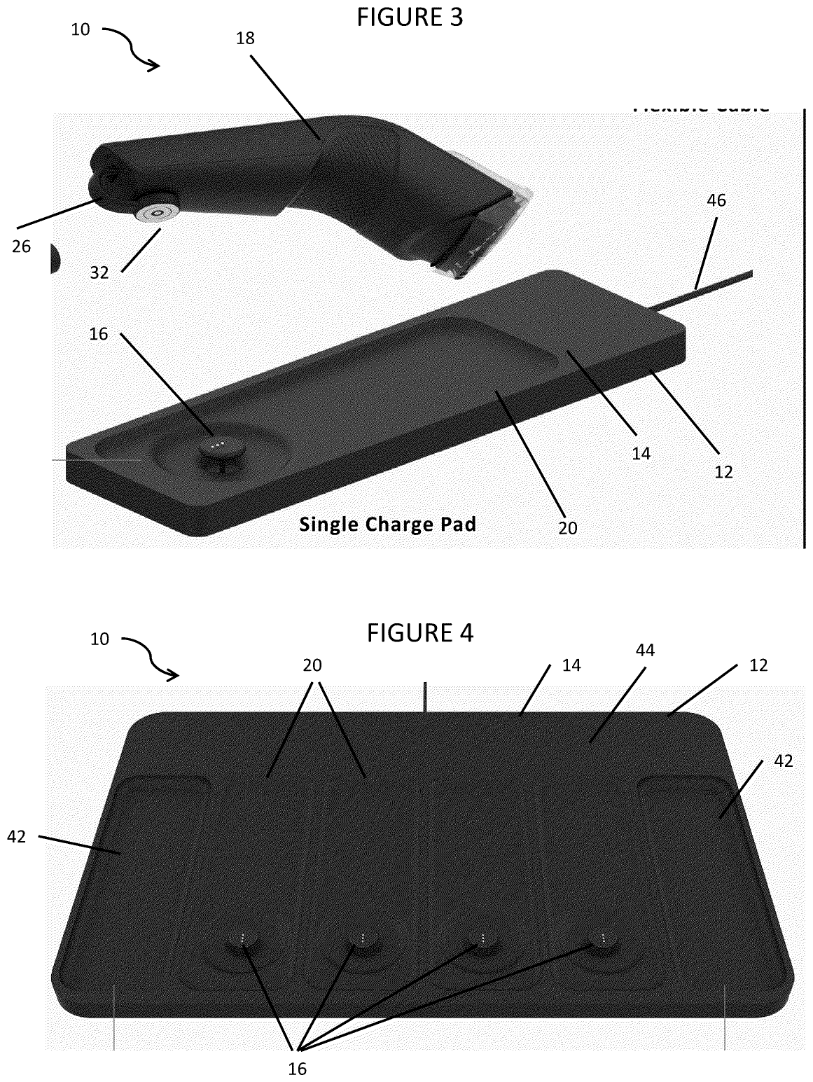

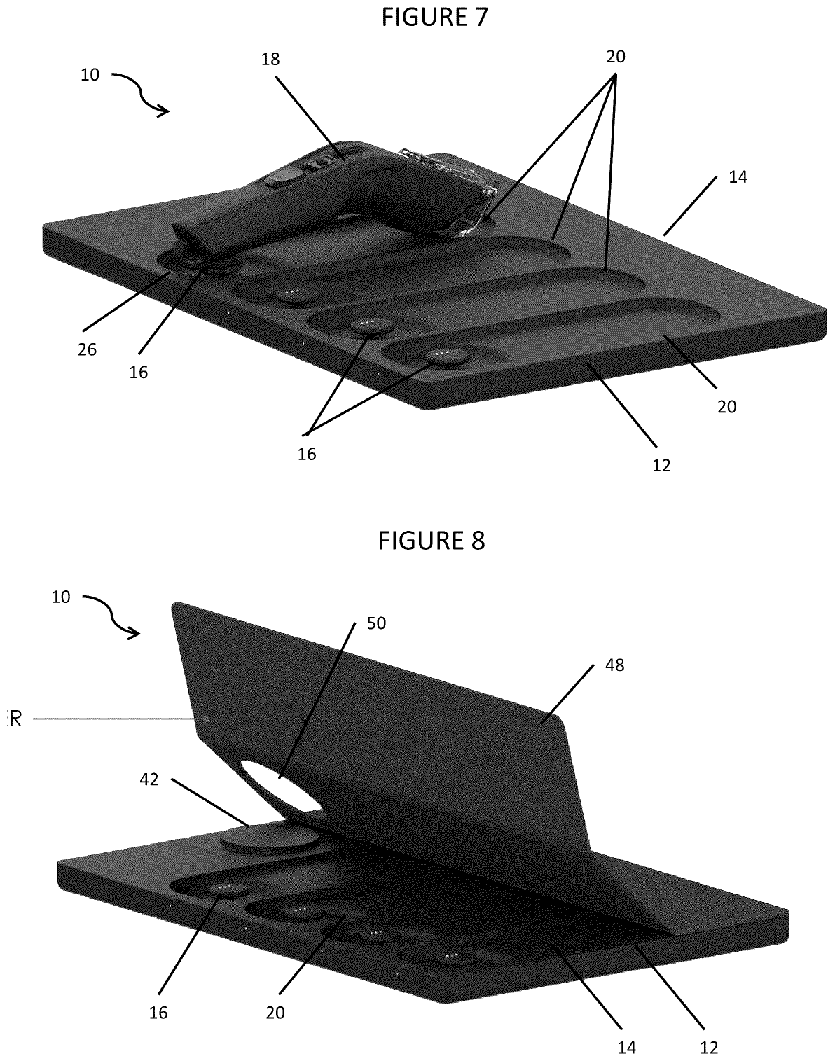

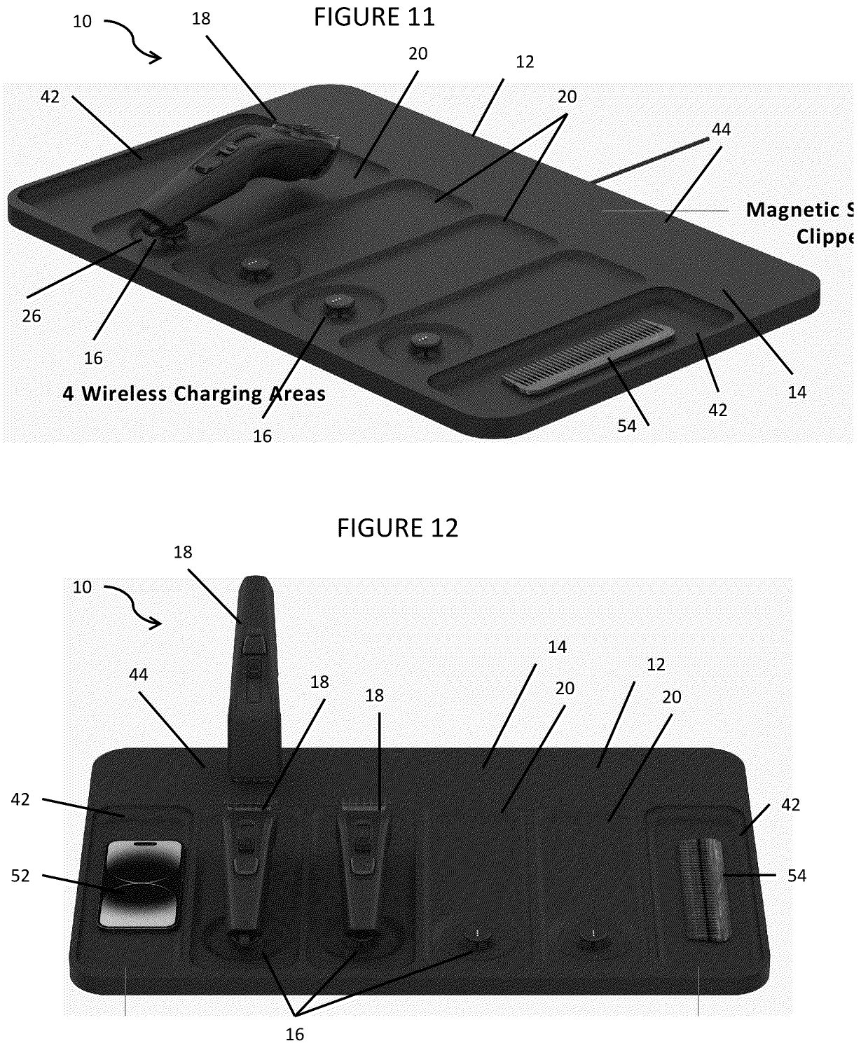

The body 12 can be substantially flat and sized to receive and hold a single hair trimmer 18 (FIGS. 1-3) or multiple hair trimmers 18 (FIGS. 4-14). The body 12 is preferably made of silicone for robustness and providing minimal slippage of objects thereon and ease of clean-up. Other materials can be used, such as other plastics, metals, or rubbers. The body 12 can be in any color or include a design or logo printed thereon. Representative sizes include 4.3 inches wide by 14 inches long for a single hair trimmer 18, and 23.6 inches wide by 15.2 inches long for multiple hair trimmers 18. The depth of the body 12 can be 0.7 inches.

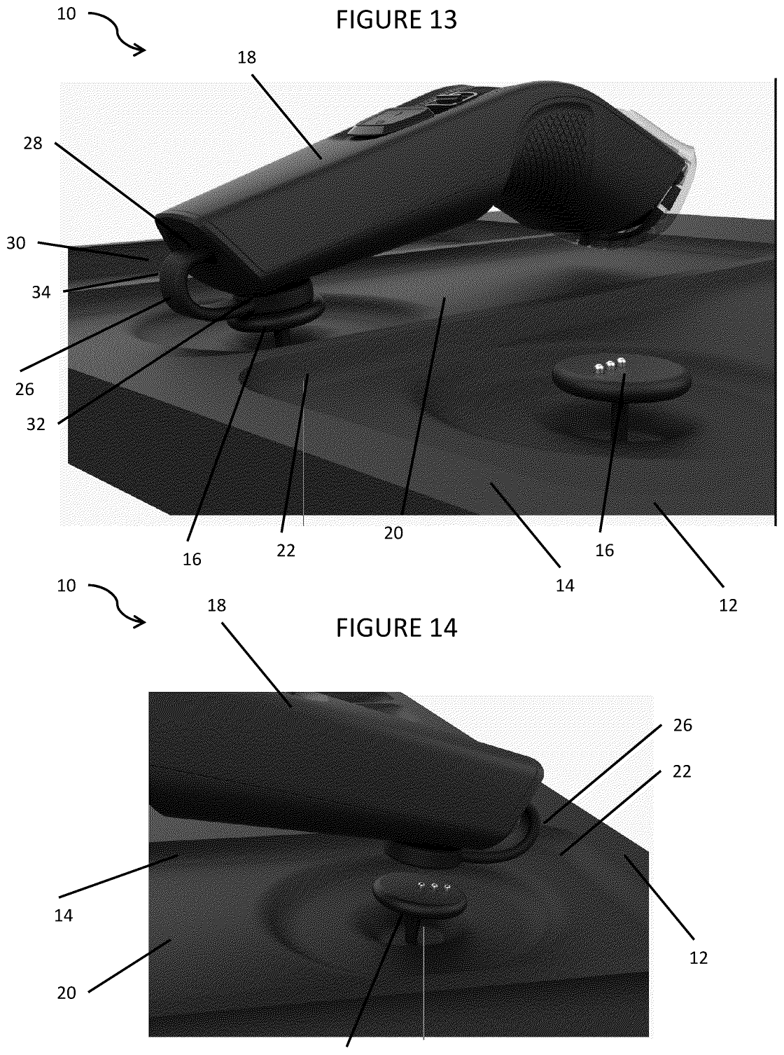

The top surface 14 of the body 12 can include at least one recessed area/charging bay 20 surrounding the magnetic contact charging point 16 sized for a hair trimmer 18. The recessed area 20 can be any suitable size for containing a hair trimmer therein. Any recessed area 20 can include a ramped lip 22 for easy cleaning, shown in detail in FIG. 13.

The magnetic contact charging point 16 can be a wireless magnetic pogo pin 24 that use 5-10 Watts and provide an output of power. The magnetic contact charging points 16 allow a user to easily align to their hair trimmers 18, eliminating any doubt that the hair trimmers 18 are being charged. The magnetic contact charging points 16 provide enough power to charge the hair trimmers 18 at virtually the same rate as plugging directly into a wall outlet.

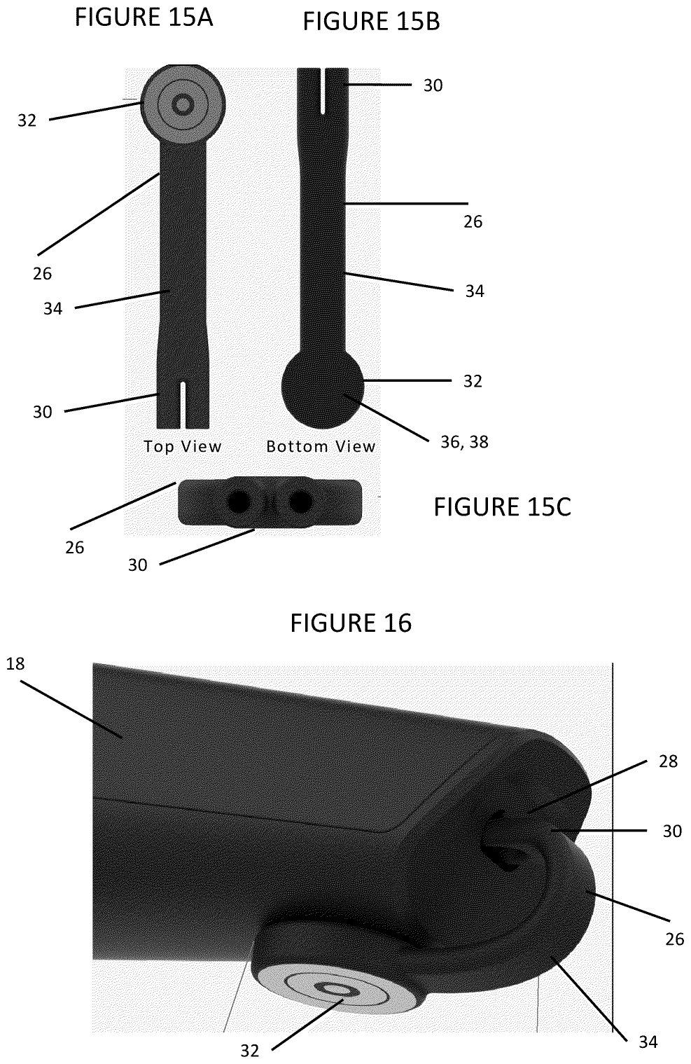

In order to charge a hair trimmer 18, a wireless charging adapter 26 is inserted in a charging port 28 of the hair trimmer 18 (shown in detail in FIGS. 15A-15C and FIG. 16). More specifically, the wireless charging adapter 26 includes a trimmer connection end 30 (such as fits a FIG. 8 connection (used by Wahl, Babyliss Pro, Andes, and others), barrel pin connection, USB-C connection, or any other connection used by a hair trimmer 18) and a wireless charging end 32 (using magnetic pogo pins) connected by a flexible cable 34. The flexible cable 34 allows for adapting the wireless charging adapter 26 to multiple sizes of hair trimmers 18. A bottom surface 36 of the wireless charging end 32 can include adhesive 38 (such as 3M adhesive) that provides enough sticking power to adhere the wireless charging end 32 to a hair trimmer 18 without damaging any surfaces thereof. For example, the bottom surface 36 can be adhered to any surface area of the hair trimmer 18 that contacts the magnetic contact charging point 16. The wireless charging end 32 (magnetic pogo pin) receives power from the magnetic contact charging point 16 (magnetic pogo pin) to power the hair trimmers 18. This creates an easy-to-use ecosystem that can make charging as easy as dropping hair trimmers 18 on to the mat. The wireless charging adapter 26 allows a user to convert any set of hair trimmers 18 to be capable of wireless charging, providing the ability to drop and charge when not using the hair trimmers 18 and making sure that a user always has enough battery to finish cutting hair.

The body 12 can include at least one charging indicator light 40 for each magnetic contact charging point 16 as shown in FIG. 6. The charging indicator light 40 can be different colors or states for different indications. Green can indicate nothing is charging in the recessed area/charging bay 20, red can indicate that a hair trimmer 18 is charging, and blinking red can indicate a charging issue.

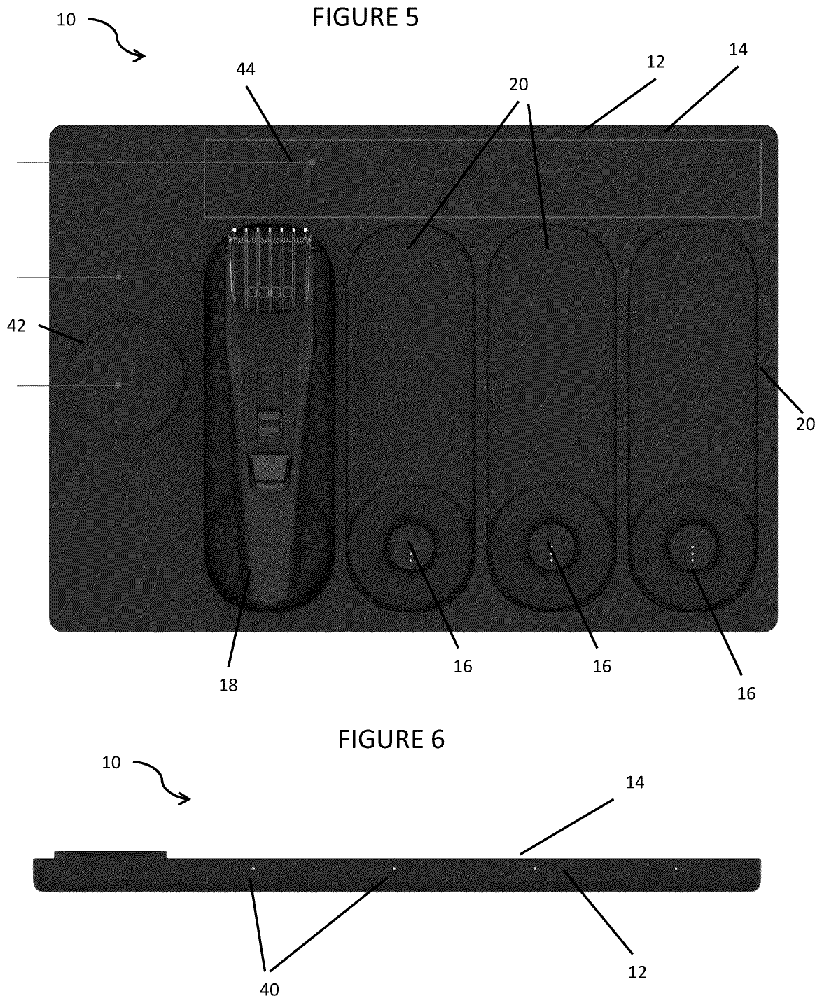

The body 12 can further include additional charging spots at any suitable location on the top surface 14. For example, at least one wireless charging surface 42 such as a Qi charging pad can be included for charging items with wireless charging capabilities such as smartphones 52 (shown in FIG. 12) or smartwatches (such as allowing for the barber to charge a smartphone as well as allowing for a customer to charge their smartphone while receiving a haircut). Such surfaces allow for inductive charging through electromagnetic induction between planar coils. This allows a user to simply place their smartphone on the wireless charging surface 42 and charge their smartphone. The wireless charging surface 42 can also provide an area for ancillary items such as shears, combs 54 (shown in FIG. 12), or guards. The wireless charging surface 42 can be raised (FIG. 5) or recessed (FIG. 4) compared to the top surface 14. A magnetic strip 44 of any suitable size can be included on the top surface 14 for quick charging of hair trimmers 18. A hair trimmer 18 can stand up on its head on the magnetic strip 44 for quick access.

The body 12 is powered by a single power cable 46 (shown in FIG. 10) and includes any necessary electronics for control of the magnetic contact charging points 16, charging indicator lights 40, and additional charging spots. The single power cable 46 allows a user to free up wall outlet space. The power cable can use AC/DC power or be a USB cable. The power cable 46 can be located any suitable place on the body 12.

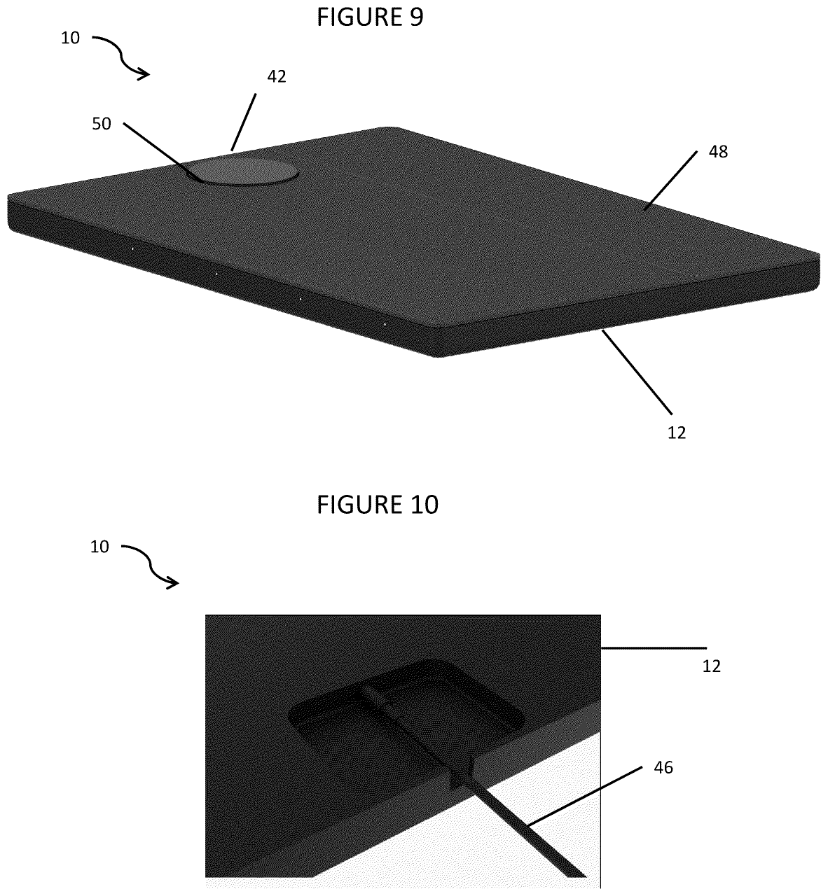

The wireless charge mat 10 can further include a cover 48 that is operatively attached to or separate from the body 12, shown in FIGS. 8-9. The cover 48 can be magnetically attachable and removable. The cover 48 can include at least one cut out 50 corresponding to a wireless charging surface 42 of the body so that a device with wireless charging capabilities such as a smartphone or smartwatch can be charged while the rest of the body 12 remains covered.

The present invention also provides for a kit, including the wireless charge mat 10, and at least one wireless charging adapter 26 for adapting the hair trimmer 18 to receive wireless charge. The kit can include multiple wireless charging adapters 26 if different trimmer connection ends 30 are needed due to the type of hair trimmer 18. The kit can further include any instructions needed to operate the wireless charge mat 10.

The present invention provides for a method of using the wireless charge mat 10, by adapting a hair trimmer 18 for wireless charging, placing the hair trimmer 18 on a magnetic contact charging point 16 of the body, and charging the hair trimmer 18. Adapting the hair trimmer 18 for wireless charging is accomplished by inserting the trimmer connection end 30 of the wireless charging adapter 26 in the charging port 28 of the hair trimmer 18, and optionally adhering the bottom surface 36 of the wireless charging adapter 26 to the hair trimmer 18. The wireless charging end 32 of the wireless charging adapter 26 makes magnetic contact with the magnetic contact charging point 16 of the wireless charge mat 10 and provides power and charge to the hair trimmer 18. These steps can be repeated for multiple hair trimmers 18. Once charged, the hair trimmer 18 can be used again. The wireless charging adapter 26 can remain on the hair trimmer 18 after charging or it can be removed. The method can also include the steps of charging additional items wirelessly on the wireless charging surfaces 42 such as smartphones or smartwatches, or placing ancillary items on the wireless charging surfaces 42. The method can also include the step of charging a hair trimmer 18 on the magnetic strip 44. The method can include verifying charging status of a hair trimmer 18 by checking a charging indicator light 40 on the wireless charge mat 10. Cover 48 can be placed on the top surface 14 of the wireless charge mat 10 when not in use.

There are several advantages to the wireless charge mat 10, such as it is ergonomic, lightweight, easy to use, clean and tidy, and it is cross-compatible/universal with different types of hair trimmers.

Throughout this application, various publications, including United States patents, are referenced by author and year and patents by number. Full citations for the publications are listed herein. The disclosures of these publications and patents in their entireties are hereby incorporated by reference into this application in order to more fully describe the state of the art to which this invention pertains.

The invention has been described in an illustrative manner and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A wireless charge mat for charging hair trimmers comprising a body having a top surface with at least one magnetic contact charging point operatively attached thereto for receiving a hair trimmer adapted for wireless charging.

2. The wireless charge mat of claim 1, wherein said body is substantially flat and is a size chosen from the group consisting of a size to receive a single hair trimmer and a size to receive multiple hair trimmers.

3. The wireless charge mat of claim 1, wherein said body is made of a material chosen from the group consisting of silicone, plastics, metals, and rubbers.

4. The wireless charge mat of claim 1, wherein said top surface includes at least one recessed area surrounding said magnetic contact charging point sized for a hair trimmer.

5. The wireless charge mat of claim 4, wherein said recessed area includes a ramped lip.

6. The wireless charge mat of claim 1, wherein said magnetic contact charging point is a wireless magnetic pogo pin.

7. The wireless charge mat of claim 1, wherein said body includes at least one charging indicator light for each said magnetic contact charging point.

8. The wireless charge mat of claim 1, wherein said body further includes a charging surface chosen from the group consisting of at least one wireless charging surface, a magnetic strip on said top surface for quick charging, and combinations thereof.

9. The wireless charge mat of claim 1, wherein said body includes a power cable and electronic controls.

10. The wireless charge mat of claim 1, wherein said wireless charge mat includes a cover.

11. A kit comprising a wireless charge mat, at least one wireless charging adapter for adapting a hair trimmer to receive wireless charge, and instructions for use, said wireless charge mat including a body having a top surface with at least one magnetic contact charging point operatively attached thereto for receiving a hair trimmer adapted for wireless charging.

12. The kit of claim 11, wherein said wireless charging adapter includes a trimmer connection end and a wireless charging end connected by a flexible cable.

13. The kit of claim 12, wherein a bottom surface of said wireless charging end includes adhesive for adhering said wireless charging end to said hair trimmer.

14. A method of using a wireless charge mat, including the steps of:
adapting a hair trimmer for wireless charging;
placing the hair trimmer on a magnetic contact charging point of the wireless charge mat; and
charging the hair trimmer.

15. The method of claim 14, wherein said adapting step is further defined as inserting a wireless charging adapter in a charging port of the hair trimmer.

16. The method of claim 15, further including the step of adhering a bottom surface of the wireless charging adapter to the hair trimmer.

17. The method of claim 14, further including the step of charging items wirelessly on a wireless charging surface on the wireless charge mat.

18. The method of claim 17, wherein said items are chosen from the group consisting of smartphones, smartwatches, and combinations thereof.

19. The method of claim 14, further including the step of verifying charging status of a hair trimmer by checking a charging indicator light on the wireless charge mat.

20. The method of claim 14, further including the step of placing a cover on a top surface of the wireless charge mat when not in use.
